(19) United States
(12) Patent Application Publication
(10) Pub. No.: US 2005/0040827 A1
(43) Pub. Date: Feb. 24, 2005

(54) NMR probe with flow restriction element

(76) Inventors: Tal Cohen, Herzlia (IL); Paul J. Giammatteo, Southbury, CT (US); John C. Edwards, Poughkeepsie, NY (US); Uri Rapoport, D.N. Merkaz (IL); Naim Levi, D.N. Merkaz (IL)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/751,551

(22) Filed: Jan. 5, 2004

Related U.S. Application Data
(60) Provisional application No. 60/438,441, filed on Jan. 7, 2003.

(51) Int. Cl. G01V 3/00

(52) U.S. Cl. 324/321; 324/303; 324/306; 324/322

(57) ABSTRACT

A Nuclear Magnetic Resonance (NMR) probe including a conduit to provide a sample, a measurement region in fluid communication with the conduit, and at least one restriction element to at least partially restrict flow of the sample from the measurement region in at least one flow direction.

### CLAIM OF PRIORITY

This application claims priority to provisional application U.S. Ser. No. 60/438,441, entitled “NMR PROBE WITH SAMPLE CONTAINMENT,” and filed on Jan. 7, 2003, the contents of which are herein incorporated by reference in their entirety.

### BACKGROUND

(1) Field

The device relates to nuclear magnetic resonance (NMR) testing apparatus and more particularly to NMR spectrometer probes.

(2) Description of Relevant Art

Atomic nuclei can include an odd number of neutrons (negatively charged) or protons (positively charged), and these spinning nuclei create micro-magnetic fields such that a nucleus can resemble a bar magnet (e.g., magnetic moment) with the north and south poles along the axis of spin. Because nuclei are typically oriented randomly, there is generally not a net magnetic field, but when the nuclei are exposed to a strong and uniform external magnetic field, the nuclei can assemble or align with the field to create a detectable magnetic field. The aligned magnetic moments precess about the axis of the field at a frequency dependent on the strength of the applied magnetic field and on the characteristics of the nuclei.

The spin frequency can be expressed as a product of the applied magnetic field strength and a gyromagnetic constant that is specific to the nuclear species, where such product can otherwise be known as the Larmor frequency. Because the gyromagnetic constant is species-specific, specific nuclei under a given magnetic field will spin at a predictable frequency. Accordingly, when the applied magnetic field changes, the spin frequency for the specific nuclei changes.

When a radio frequency (RF) electromagnetic wave at the Larmor frequency is applied to the atomic nuclei, the atomic nuclei absorb energy from the RF wave and enter an excitation state known as resonance. Discontinuation of the RF wave causes the atoms to relax to the equilibrium state and release the absorbed energy as RF emissions, where appropriate sensors can detect such emissions. Such emissions can be referred to as the free induction relay (FID). The FID can otherwise be understood as the energy release or relaxation rate of the nuclei.

Accordingly, NMR can be performed using a spectrometer that can include a probe for accepting the sample. The probe can be positioned between poles of a fixed or permanent magnet or other device for providing a first magnetic field that is a fixed magnetic field. The sample can additionally be exposed to a second pulsed magnetic field that can be accomplished by, for example, subjecting the sample to RF electromagnetic pulses. RF coils and tuning circuitry associated with the probe can create the second pulsed magnetic field that rotates the net magnetization of the sample nucleus. These RF coils can also detect or measure the FID.

When the RF coil pulses the sample nucleus at the Larmor frequency, the emitted signals can provide a spectrum having a recognizable maximum and/or otherwise providing a signature that can be compared to spectrums for reference samples, for example, to assist in identifying the sample. NMR thus has various applications, including, for example, determining the constituents of the sample.

An exemplary NMR probe is disclosed in U.S. Pat. No. 5,371,464 (Rapoport), incorporated by reference herein in its entirety.

A disadvantage of some probes includes an inability to contain a sample in an area that corresponds to the poles of the fixed and/or permanent magnet. For example, when a sample is a gaseous sample, Brownian motion, diffusion, etc., can cause the gas to move away from a measurement region that may be understood to be between the poles of the magnet. Other containment issues may also be relevant for non-gaseous (e.g., liquid, semi-solid, etc.) samples. Dissipation of the sample from within the measurement region can lead to erroneous or sporadic measurements and thus the NMR results can be inaccurate, and in some cases, worthless. A similar movement of the sample can occur when a fluid sample is used.

### SUMMARY

The disclosed methods and systems include a Nuclear Magnetic Resonance (NMR) probe that includes a conduit to provide a sample, a measurement region in fluid communication with the conduit, and at least one restriction element to at least partially restrict flow of the sample from the measurement region in at least one flow direction. The restriction element(s) can be biased to at least partially seal at least one opening between the conduit and the measurement region. The restriction element(s) can be disposed in the measurement region and/or the conduit.

The restriction element(s) can be non-magnetic, and can be titanium, glass, and ceramic. Similarly, a biasing element and/or biasing means can be non-magnetic, and can be titanium, glass, and ceramic. The restriction element(s) can conform to at least one opening between the conduit and the measurement region, and can be spherical, circular, ovoid, conical, polygonal and/or planar.

The biasing means and/or element can displace the restriction element(s). The biasing means can include the sample, at least one spring, a compressible material, an expandable material, a bending resistant material, a gravitational influence, a mechanical actuation, and/or an electrical actuation. A manual and/or processor-based controller can operate on the restriction element to adjust the biasing means to maintain an opening between the conduit and the measurement region.

In one embodiment, the probe includes a constriction disposed between the conduit and the measurement region to contact the restriction element.

Also disclosed is a NMR probe including a measurement region to contain a sample, a conduit in fluid communication with the measurement region, at least one valve disposed between the measurement region and the conduit to control a flow of the sample between the measurement region and the conduit. In an embodiment, the valve(s) can be a check valve and/or a ball check valve. The valve(s) can be non-magnetic.

Disclosed is a NMR probe including a measurement region to contain a sample, and at least one means for controlling flow of the sample from the measurement region during measurement of the sample. The probe can also include a conduit in fluid communication with the measurement region to facilitate flow of the sample into the measurement region, and where the at least one means for controlling flow at least partially restricts the flow of the sample from the measurement region to the conduit. The means for controlling flow can include at least one valve that may be disposed between the measurement region and the conduit. The valve(s) can be non-magnetic.

### BRIEF DESCRIPTION OF THE DRAWINGS

FIG. 1 is a front view of one embodiment of a NMR probe;

FIG. 2 provides an expanded view of one embodiment of the chamber of FIG. 1;

FIG. 3 provides an expanded view of another embodiment of the chamber of FIG. 1;

FIG. 4 provides an expanded view of another embodiment of the chamber of FIG. 1; and,

FIG. 5 shows an embodiment with two restriction elements.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and/or aspects of the illustrations can be otherwise combined, separated, interchanged, and/or rearranged without departing from the disclosed systems or methods. Additionally, the shapes and sizes of components are also exemplary, unless otherwise provided, and can be altered without affecting the disclosed systems or methods.

The disclosed methods and systems include a NMR probe that can include a containment means or other device for at least partially restricting the flow of a sample for NMR measurement within a measurement region of the probe, where in one embodiment, the measurement region can be understood to be associated with the fixed and/or permanent magnet. For the purposes of the disclosed methods and systems, at least partially restricting can be understood to include completely restricting flow of the sample in at least one direction. Further, although the disclosed embodiments may be discussed relative to gaseous samples, those of ordinary skill will understand that liquid, semi-solid, non-gaseous, and other sample types may also be contained in the measurement region by the disclosed methods and systems.

In one embodiment, a disclosed NMR probe can include or otherwise interface to a conduit for presenting the sample to the measurement region. In one embodiment, the containment means can include at least one valve disposed to allow flow into the measurement region, but which may also at least partially restrict flow of the sample out of the measurement region. The flow restriction can be in one or more flow directions. In the exemplary embodiment of a valve, the valve(s) can be fabricated of a non-magnetic material. Those of ordinary skill will understand a valve, as provided herein, to be defined based on operation rather than shape, and to be generally one or more devices that regulate the flow of gases, liquids, or loose materials through piping or through apertures by opening, closing, or obstructing ports or passageways (e.g., conduit and/or measurement region).

In one embodiment, the valve(s) can provide a flow of the sample into the measurement region. Additionally and optionally, the valve(s) may be connected to a controller (e.g., manual, microprocessor-based) that can operate to open and/or close the valve(s) to control flow of the sample into and/or out of the measurement region.

In one embodiment, the valve(s) may be operate in a check valve manner, i.e., the valve(s) may operate to allow sample flow in a first direction. When sample flow in the first direction stops, or, when sample flow in an opposite direction begins, an restriction element can be displaced within the flow path to at least partially restrict flow of the sample past the valve(s) in the opposite direction. In one embodiment, the restriction element can be configured as a hinged flap that can rotate about the hinge to allow and/or at least partially restrict flow.

In an embodiment, the restriction element can be disposed within the flow path and the sample can flow around at least a portion of the restriction element in the first direction. The restriction element can be displaced to a constricted portion of the flow path such that the restriction element can at least partially restrict flow in the same and/or another (e.g., opposite direction). The restriction element can be spherical, conical, polygonal, or another shape that can mate with and block the constricted portion of the flow path to at least partially restrict sample flow in a direction. The restriction element can be physically disposed within the measurement region and/or within the conduit in communications with the measurement region. (It can be understood that in embodiments, the measurement region may be considered a part of the conduit.)

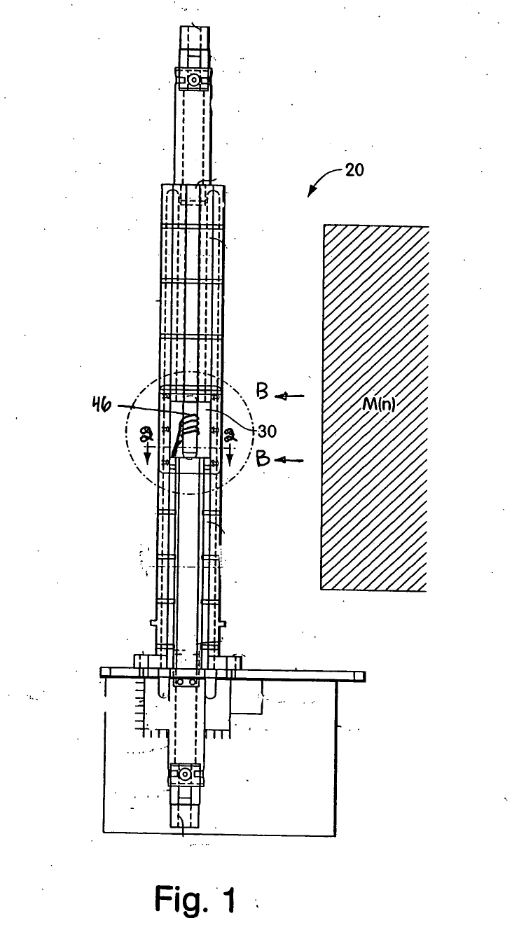

FIG. 1 shows generally one embodiment of an NMR probe 20 according to the probe disclosed herein where the probe includes a conduit having a measurement region. The illustrated probe 20 is in use with a magnet M (typically having north “N” and south “S” poles) that generates a magnetic field (indicated by the vector B). The magnet M can be part of a system such as that detailed in U.S. Pat. No. 5,371,464, incorporated by reference herein in its entirety, designed to accommodate a probe, such as probe 20 of FIG. 1.

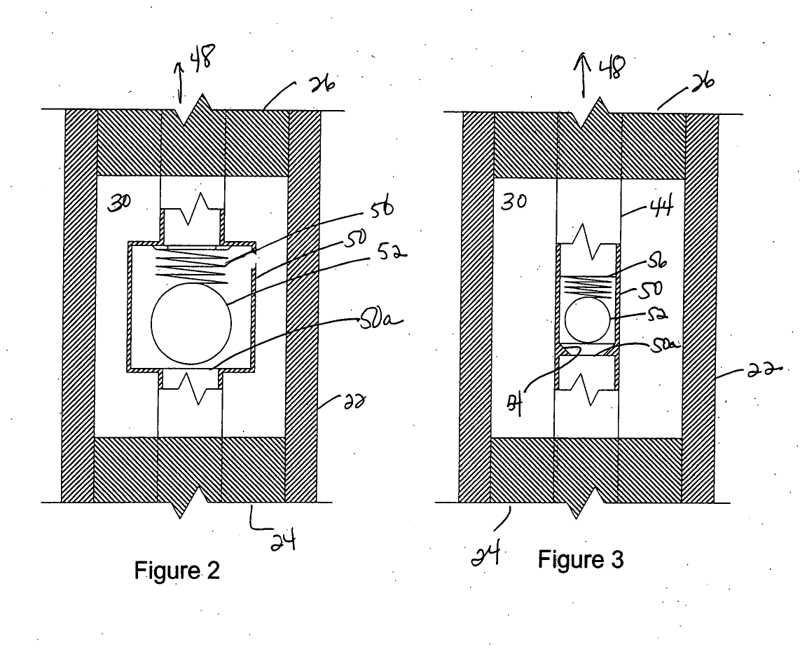

Referring now to FIG. 2, the a measurement region 50 can be located in chamber 30 along the conduit 44 though other locations may also be used. It can also be understood that chamber 30 can form measurement region 50, with conduit 44 not extending into chamber 30, or chamber 30 may be fabricated as part of conduit 44. For illustrative purposes, portions of conduit 44 are removed to reveal interior portions of measurement region 50. In the embodiment of FIG. 2, restriction element 52 can be disposed within measurement region 50 and can be biased against a downstream end 50a of measurement region 50, to at least partially restrict flow through the opening between the conduit 44 and the measurement region 50. Flow of the sample through conduit 44 and measurement region 50, as indicated by flow direction arrow 48, can overcome the biasing of restriction element 52 so as to move restriction element 52 away from downstream end 50a and allow sample flow around restriction element 52 and into measurement region 50.

For the FIG. 2 embodiment, when flow in the direction 48 stops, the biasing of restriction element 52 can cause restriction element 52 to at least partially obstruct downstream end 50a to at least partially restrict flow in the direction opposite to direction 48, i.e., from measurement region 50, through downstream end 50a and into conduit 44. Restriction element 52 can be biased away from downstream end 50a. In this alternate configuration, flow in the direction opposite to direction 48 can overcome the biasing so as to move restriction element 52 against downstream end 50a and thus at least partially restrict the flow in the direction opposite to direction 48.

In the embodiment of FIG. 2, measurement region 50 is shown having a larger diameter than conduit 44. FIG. 3 can show an alternate embodiment of the measurement region 50 and conduit 44, wherein measurement region 50 has the same diameter as conduit 44. In this illustrative embodiment, a constriction 54 can be disposed within conduit 44, and/or within measurement region 50, at a downstream end 50a of measurement region 50. Restriction element 52 can be biased against constriction 54 and can operate in a manner similar to restriction element 52 of FIG. 2 to at least partially restrict flow in a direction opposite flow direction 48.

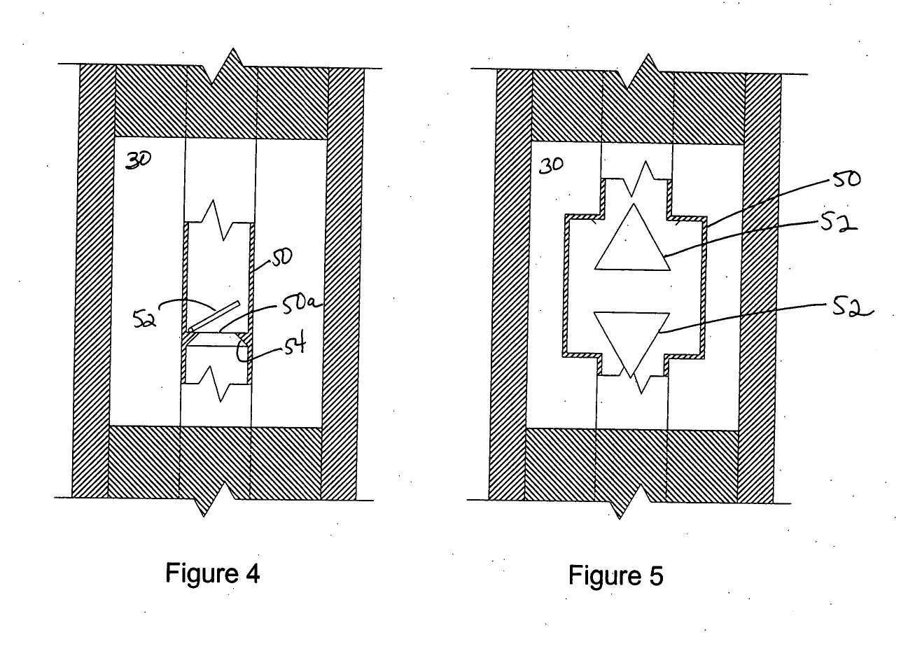

In a further embodiment illustrated in FIG. 4, restriction element 52 can be configured as a flap biased against downstream end 50a of measurement region 50. The flap 52 can operate in a manner similar to restriction element 52 of FIG. 2 to at least partially restrict flow in a direction opposite flow direction 48. As described for the embodiment of FIG. 3, the flap 52 can be configured such that the measurement region 50 can have the same diameter as conduit 44, with flap 52 being biased against a constriction 54 at downstream end 50a. Restriction element 52 can be configured to operate in an enlarged measurement region, as described with relation to FIG. 2.

As illustrated in the exemplary embodiments of FIGS. 2 and 3, restriction element 52 can have a spherical shape. It can be understood that restriction element 52 can be fabricated in shapes other than spherical that may also at least partially restrict sample flow when biased against downstream end 50a. As non-limiting examples, restriction element 52 can be fabricated having a conical shape, an ovoid shape, a polygonal shape, or another shape that may at least partially seal against the downstream end 50a to at least partially restrict flow in the direction opposite to direction 48. In one embodiment restriction element 52 can be planar. It can also be understood that restriction element 52 of FIG. 4 can be fabricated in shapes other than the exemplary planar shape shown in FIG. 4, including, but not limited to, the shapes as described with relation to the embodiments of restriction elements 52.

Biasing of restriction element 52 can be provided by means suitable to the operation of the probe 20. In FIGS. 2 and 3, such biasing means 56 are illustrated as a spring. Non-limiting examples of providing biasing can include springs, bending of lever arms, compressible or expandable materials, mechanically or electrically actuated switches, or any other biasing means as may be known. One of skill in the art can appreciate that restriction element 52 fabricated of bendable, compressible and/or expandable materials can be self-biasing, e.g., by bending of flap 52. Biasing may also be provided by gravitational and/or other external forces acting on the restriction element 52. In one embodiment, biasing may be controlled by a controller (e.g., manual, microprocessor-based) that may be incorporated with probe 20 or may be separate from probe 20. In this embodiment, which can be suited for, but not necessarily limited to, use with biasing means such as mechanically or electrically actuated switches, the controller may operate the biasing means to allow sample flow in the direction opposite to direction 48 so as to evacuate the sample from measurement region 50.

The disclosed methods and systems thus allow a sample to be introduced to or entered into a probe 20, where the sample may flow through the conduit 44 and into the measurement region 50, where an restriction element may be used to at least partially restrict flow of the sample to allow the sample to remain in the measurement region 50 while NMR analysis is performed. It can be understood from the above that restriction element 52 can be fabricated of non-magnetic material that may withstand the temperatures and pressures used in NMR analysis. Such materials can include, but not be limited to, titanium and other metallic, non-magnetic materials, glass, ceramic, plastics and other non-metallic, non-magnetic materials.

FIG. 5 shows an embodiment having two restriction elements 52A, 52B where neither of the restriction elements is associated with a biasing means. Accordingly, in such an embodiment, the flow of the sample can be understood to provide a bias such that the sample flow can cause the restriction elements 52A, 52B to be positioned to at least partially restrict flow out of the measurement region 50. Those of ordinary skill will recognize that in another embodiment according to FIG. 5, a single restriction element can be used to at least partially restrict flow in a single direction.

While the method and systems have been disclosed in connection with the illustrated embodiments, various modifications and improvements thereon will become readily apparent to those skilled in the art. For example, the structure provided herein included a mostly rectangular body with a circular conduit, etc. Those with ordinary skill in the art will recognize that such shapes and sizes are merely for illustrative purposes, and can be varied accordingly based on application without departing from the scope of the disclosed methods and systems. Accordingly, the body can be cylindrical, spherical, square, or another shape, and is not limited to the rectangular shape provided in the illustrated embodiment. The conduit and openings for the conduit can similarly be another shape besides the circular (cross-section) shape provided herein, including, e.g., rectangular, triangular, square, etc. The connection between the restriction element and the controller can be wired or wireless or can be through a wired or wireless network. Additionally, more than one restriction element can be provided to at least partially restrict flow in other directions and/or in other areas of the probe.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

The aforementioned changes are also merely illustrative and not exhaustive, and other changes can be implemented without affecting the ability of the probe to include a body that is temperature controlled. Accordingly, many additional changes in the details, materials, and arrangement of parts, herein described and illustrated, can be made by those skilled in the art. It will thus be understood that the following claims are not to be limited to the embodiments disclosed herein, can include practices otherwise than specifically described, and are to be interpreted as broadly as allowed under the law.

1. A Nuclear Magnetic Resonance (NMR) probe, comprising:
a conduit to provide a sample,
a measurement region in fluid communication with the conduit, and
at least one restriction element to at least partially restrict flow of the sample from the measurement region in at least one flow direction.

2. The NMR probe of claim 1, where the at least one restriction element is biased to at least partially seal at least one opening between the conduit and the measurement region.

3. The NMR probe of claim 1, where the at least one restriction element is disposed in at least one of: the measurement region and the conduit.

4. The NMR probe of claim 1, where the at least one restriction element is non-magnetic.

5. The NMR probe of claim 4, where the restriction element includes at least one of titanium, glass, and ceramic.

6. The NMR probe of claim 1, where the at least one restriction element conform to at least one opening between the conduit and the measurement region.

7. The NMR probe of claim 1, where the restriction element is at least one of: spherical, circular, ovoid, conical, polygonal and planar.

8. The NMR probe of claim 1, further comprising at least one biasing means to displace the at least one restriction element.

9. The NMR probe of claim 8, where the biasing means includes at least one of: the sample, at least one spring, a compressible material, an expandable material, a bending resistant material, a gravitational influence, a mechanical actuation, and an electrical actuation.

10. The NMR probe of claim 8, further comprising a controller operating on the restriction element to adjust the biasing means to maintain the opening between the conduit and the measurement region.

11. The NMR probe of claim 1, further comprising a constriction disposed between the conduit and the measurement region to contact the restriction element.

12. A Nuclear Magnetic Resonance (NMR) probe, comprising:
a measurement region to contain a sample,
a conduit in fluid communication with the measurement region, and,
at least one valve disposed between the measurement region and the conduit to control a flow of the sample between the measurement region and the conduit.

13. The NMR probe of claim 12, where the at least one valve is a check valve.

14. The NMR probe of claim 12, where the at least one check valve is a ball check valve.

15. The NMR probe of claim 12, where the at least one valve is non-magnetic.

16. A Nuclear Magnetic Resonance (NMR) probe, comprising:
a measurement region to contain a sample, and
at least one means for controlling flow of the sample from the measurement region during measurement of the sample.

17. The NMR probe of claim 16, further comprising a conduit in fluid communication with the measurement region to facilitate flow of the sample into the measurement region, and where the at least one means for controlling flow at least partially restricts the flow of the sample from the measurement region to the conduit.

18. The NMR probe of claim 16, where the means for controlling flow is at least one valve.

19. The NMR probe of claim 16, where the at least one valve is disposed between the measurement region and the conduit.

20. The NMR probe of claim 16, where the at least one valve is non-magnetic.
